(19) United States
(12) Patent Application Publication
(10) Pub. No.: US 2004/0228250 A1
(43) Pub. Date: Nov. 18, 2004

(54) Disk apparatus adjustment method and disk apparatus

(75) Inventors: Tatsuya Ishitobi, Kawasaki (JP); Hiroaki Ono, Fujisawa (JP); Hisataka Sugiyama, Kodaira (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/652,969

(22) Filed: Aug. 28, 2003

(30) Foreign Application Priority Data
May 16, 2003 (JP) 2003-138094

(51) Int. Cl. G11B 7/00

(52) U.S. Cl. 369/53.37; 369/116; 369/53.18

(57) ABSTRACT

In a method of adjusting a disk apparatus, if adjustment processing has to be performed prior to processing which the user expects to be performed soon, the adjustment processing can be finished in a short time and thus the processing requested by the user can be performed at once enough to meet the user's expectation. A database concerning the adjustment processing is created at the time when the user of the disk apparatus accepts the much time taken to perform the processing requested by the user. Then, when the user makes a request to perform processing, which the user expects to be performed at once, the adjustment processing which has to be performed prior to the performance of the processing requested by the user is performed based on the database to speed up the adjustment processing, thus making it possible to perform the processing requested by the user at once.

### BACKGROUND OF THE INVENTION

1. Field of the Invention

The present invention relates to a disk apparatus, and more particularly, to processing for adjustment of the disk apparatus which has to be performed prior to the execution of processing of the disk apparatus.

2. Description of the Related Art

In order to record or play back data onto or from a disk of a disk apparatus, it is necessary to make an appropriate adjustment to a survo, laser power of the disk apparatus, or the like in advance. The adjustment items include what requires to be adjusted only once at factory shipment and what requires to be adjusted repeatedly every time the apparatus is powered up or temperature varies.

Especially an adjustment that takes much time for processing thereof out of the adjustment items reduces responsivity of the disk apparatus. This does not raise a big problem to a disk apparatus used for a personal computer, because in the case of the disk apparatus for the personal computer, when an adjustment has to be made prior to the start of recording, the adjustment is made while keeping a user waiting, and even if the record processing is started after the completion of the adjustment, it can record all the data requested onto the disk. This is possible because the disk apparatus for the personal computer copies data existing on a hard disk of the personal computer onto a disk within the disk apparatus.

On the other hand, in the case of a disk apparatus used for a video recording system such as a camera, a video recorder, or the like, it is required to record video information inputted in real time without fail. Thus, when a request for recording is made by a user, the disk apparatus is not allowed to keep the user waiting, even if an adjustment has to be made prior to record processing. Therefore, when an adjustment has to be made prior to the recording, it is necessary to finish the adjustment in a short time and then to initiate the record processing at once.

As an example of adjustment processing that has to be performed prior to the initiation of recording, there is a laser power adjustment in an optical disk apparatus. While power of a laser mounted on the optical disk apparatus depends on the current value supplied, there are temperature characteristics in the relation between supply current and power. Therefore, when temperature varies, it is required to adjust the supply current to the laser prior to the initiation of recording such that optimum power is provided at the time of recording.

The adjustment of laser power is generally made on a power calibration area which is provided on a disk separately from an area where data is recoded, and the supply current to the laser is varied gradually on the power calibration area and the power outputted to the laser is simultaneously measured to search supply current which provides target power. While such a laser power adjustment is made in the conventional apparatus, the adjustment method uses a power calibration area. Therefore, seek processing for moving a pickup between a data area and the power calibration area is indispensable. Thus, since time is taken for the seek processing and adjustment processing themselves, immediate record processing has been impossible.

A method of adjusting laser power in the data area is devised as a method of saving time taken for performing such seek processing or the like and to shorten the time for adjusting the laser power (Japanese Laid-open Patent Application JP-A-7-153076 (Page 4[0015], page 8, FIG. 5)). The method determines supply current which provides desired laser power while gradually varying current to be supplied to the laser in a data area on the disk where first one sector out of the data which was requested to be recorded should be recorded, and from the second sector on, recording is performed with laser power which reflects the adjustment results. It should be noted that data of the first one sector of data is temporarily stored in a memory, and is recorded after the pickup is returned to a sector position, where the data originally should have been recorded, at the time when recording of the data requested to be recorded is finished.

Since the method eliminates the necessity to move the pickup between the data area and power calibration area, seek time does not occur, thus making it possible to shorten the time otherwise taken for the seek processing. However, since the adjustment method itself is the same as the conventional one, the time taken for the adjustment can not be largely shortened. Further, since it is also necessary to advance recording of first one sector of data, total time taken for recording lengthens, thus sometimes causing inconvenience in a real time recording. Furthermore, since the method is applicable only when the data area is rewritable, it can not be used for a write-once disk such as DVD.

### SUMMARY OF THE INVENTION

In a conventional disk apparatus, when adjustment processing such as a laser power adjustment has to be performed in advance of the start of recording, it has been difficult to start recording at once. Furthermore, a conventional method devised to cope with such a problem has not paid a sufficient consideration to real time recording or recording onto a write-once disk.

The present invention provides a disk apparatus adjustment method. According to the method, even if adjustment processing has to be performed prior to the processing which the user expects to be performed at once, the adjustment can be finished in a short time, and the processing requested by the user is performed immediately enough to meet the user's expectation.

In order to solve above problems, the present invention makes a relatively time consuming adjustment during the time when, for example, the user accepts the much time taken for performing the processing requested by the user, and uses the adjustment results to create or update a database associated with the adjustment processing. Thus, when a processing request is made by the user that is expected by the user expects to be performed at once, the adjustment processing which has to be performed prior to the performance of the processing is executed in a short time based on above database, thus enabling faster adjustment processing which results in an immediate performance of the processing requested by the user.

According to the present invention, even if adjustment processing has to be performed prior to the processing which the user expects to be performed at once, the adjustment processing can be finished in a short time, thus enabling performing the processing requested by the user immediately enough to meet the user's expectation.

Other objects, features and advantages of the invention will become apparent from the following description of the embodiments of the invention taken in conjunction with the accompanying drawings.

### BRIEF DESCRIPTION OF THE DRAWINGS

FIG. 1 is a flow chart illustrating a processing cycle in an optical disk apparatus according to one embodiment of the present invention;

FIG. 2 is a diagram illustrating variations in supply current-power characteristics caused by temperatures of the same laser mounted on the optical disk;

FIG. 3 is a diagram illustrating variations in the best and worst supply current-power characteristics caused by temperature within the same lot of a laser mounted on the optical disk;

FIG. 4 is a means for creating and utilizing a database for a laser power adjustment according to one embodiment of the present invention; and

FIG. 5 is a perspective view of an exemplary DVD camera for use in the present invention.

### DESCRIPTION OF THE EMBODIMENTS

The embodiments of the present invention will be described with an adjustment of laser power in an optical disk apparatus as an example.

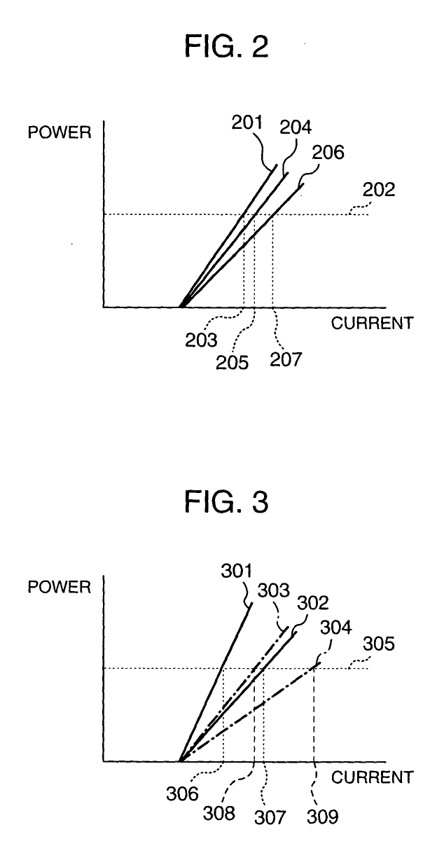

FIG. 2 illustrates a graph indicating a relationship between supply current and power of a laser mounted on the optical disk apparatus. In the graph shown in FIG. 2, the lateral axis indicates current values supplied to the laser, which increase towards right.

Further, the vertical axis indicates power values of the laser, which increase as it goes up. The relationship between supply current and power is, for example, characteristics as shown by 201 in FIG. 2. 202 shown by a broken line in FIG. 2 is a target power value of the laser. In characteristics 201, the target power value 202 is acquired by supplying the laser with a current value shown by 203.

However, supply current-power characteristics is not constant, and as temperature rises, it changes to characteristics shown by 204 of FIG. 2, and when temperature rises more, it changes to characteristics 206 of FIG. 2. Therefore, in order for the laser to provide the target power constantly, it is necessary to adjust supply current following changes of characteristics as in 205 or 207 of FIG. 2.

Therefore, the optical disk apparatus determines the current to be supplied to the laser by gradually changing the current supplied to the laser, simultaneously measuring the power and then deducing supply current which provides the target power. However, the adjustment method is performed after a pickup is moved to a power calibration area provided on the disk, which means that at least time for moving the pickup and actual adjustment is needed, thus making it impossible to perform record processing at once when an adjustment has to be made to the laser power upon receipt of a recording request from the user.

In order to allow performing record processing at once even when an adjustment has to be made to the laser power upon receipt of a recording request from the user, it is necessary to largely shorten the time taken to make an adjustment to the laser.

If the temperature characteristics of supply current-power are previously measured for each temperature, it becomes possible to estimate characteristics at each temperature. If characteristics for each temperature is previously stored in a database, even if the laser power has to be adjusted when a recording request is made by the user, characteristics corresponding to the temperature at that time is acquired at once by referring to a database, thereby making it possible to determine supply current to the laser in a short time. However, since even if the laser is from the same lot, the characteristics of the laser is not always identical at the same temperature and there are some variations in its characteristics, and so it is required to measure characteristics of each laser, which is, however, not realistic. Therefore, the present embodiment provides a method to create the database at a second step.

At the first step, variations in characteristics within the lot of the laser mounted on the disk apparatus are acquired. Variations in characteristics can be acquired from a graph such as one shown in FIG. 3. FIG. 3 is a graph showing supply current-power characteristics of the laser in the same way as FIG. 2, and 301 is the best characteristic of the laser in the lot at an ambient temperature surrounding the laser of 20° C. 302 is the worst characteristic in the lot at the ambient temperature surrounding the laser of 20° C. Further, 303 in FIG. 3 is the best characteristic in the lot at an ambient temperature surrounding the laser of 70° C., while 304 is the worst characteristic in the lot at the ambient temperature surrounding the laser of 70° C.

Assuming that 305 shown in FIG. 3 is target power of the laser, data can be acquired that there exist variations in supply current between current values 306 and 307 shown in FIG. 3 at an ambient temperature surrounding the laser of 20° C., and that there exist variations in supply current between current values 308 and 309 shown in FIG. 3 at an ambient temperature surrounding the laser of 70° C. The data allows estimating how the current, which is to be supplied to the laser, varies at ambient temperatures surrounding the laser ranging from 20° C. to 70° C. Further, storing the data acquired at the first step in the optical disk apparatus, on which a laser of the same lot is mounted, allows using the data as database common to each optical disk apparatus.

It should be noted that the graph shown in FIG. 3 or equivalent data is available from a manufacture of the laser. Database of the first step shall be created in, for example, the manufacturing factory beforehand.

At the second step, temperature characteristics of the laser mounted on the disk apparatus are deduced based on the variations in temperature characteristics of the laser in the lot acquired in the first step. Therefore, actually current values to be supplied to the laser are gradually changed, and the laser power is simultaneously measured to acquire a supply current which provides target power. An ambient temperature surrounding the laser at that time is also acquired. Then, the acquired supply current to the laser and the ambient temperature surrounding the laser are checked against the data concerning variations in temperature characteristics acquired at the first step.

In this manner, it can be estimated how the relationship between the supply current and power of the laser mounted on the disk apparatus changes at each temperature, thereby enabling creating a database concerning characteristics at each temperature. The second step finally allows creating the database particular to each optical disk apparatus. The creation of the database at the second step may be executed, for example, at the time of formatting a disk or ejecting the disk in preparation for next recording, but not limited thereto. It may also be executed when comparatively sufficient time can be spared for the processing.

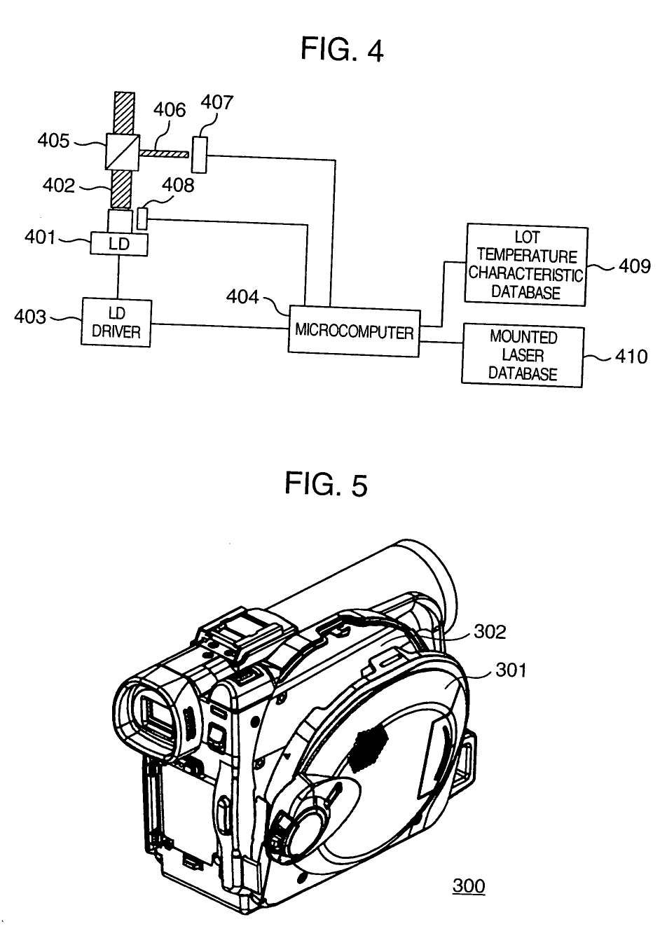

The creation and utilization of the database can be implemented by means shown in FIG. 4. In FIG. 4, 401 is a laser, 402 is light outputted by the laser 401, 403 is a laser driver for supplying current to the laser, and 404 is a microcomputer for establishing current values to be outputted by the laser driver. Further, in FIG. 4, 405 is a light separator for separating laser beam 402, 406 is separation light separated by the light separator 405, 407 is a light intensity meter for outputting voltage corresponding to the intensity of the light irradiated, and 408 is a temperature sensor for outputting voltage corresponding to the temperature in the vicinity of the laser 401.

Further, in FIG. 4, 409 is a memory in which the database concerning temperature characteristics of a lot to which the laser belongs is stored, and 410 is a memory in which temperature characteristics of the laser 401 are stored. The database concerning temperature characteristics of the entire lot of the laser is previously stored in the memory 409 at the time when the disk apparatus was manufactured or the like.

The database concerning the temperature characteristics of the laser 401 is stored in the memory 410 after the laser power is once adjusted. While the adjustment of laser power gradually changes the supply current to the laser and simultaneously measures the laser power to determine the supply current providing the target power, a phased supply of current to the laser is achieved by the microcomputer which changes the set values of the laser driver 403 in a phased manner. Further, a measurement of the laser power is achieved by the microcomputer 404 which measures a voltage value outputted by the light intensity meter 407. The ambient temperature surrounding the laser during the adjustment is also acquired by the microcomputer 404 which measures a voltage value outputted from the temperature sensor 408.

The database concerning the temperature characteristics of the laser 401 which is stored in the memory 410 is deduced by checking the supply current value to the laser 401 and the ambient temperature surrounding the laser, which were acquired by the microcomputer 404 during making an adjustment to the laser power, against the database concerning temperature characteristics of the entire lot which is stored in the memory 409 for computation. When the database is stored in the memory 410, the microcomputer 404 acquires the ambient temperature surrounding the laser via the temperature sensor 408, and refers to the database stored in the memory 410 with the acquired temperature, thus making it possible to immediately calculate a set value to be set at the laser driver. Thus, it becomes possible to acquire target power from the laser at any temperature in a short time.

FIG. 4 describes only portions that are needed for the explanation of the present embodiments. Each of the described portions is mounted on an ordinary optical disk apparatus. Therefore, memories 409, 410 do not need to be individual memories. Actually, they may be assigned to a portion of an area of rewritable nonvolatile memory used by the microcomputer. Then, the memories can be implemented by a portion of the existing memories without adding a memory for a new database.

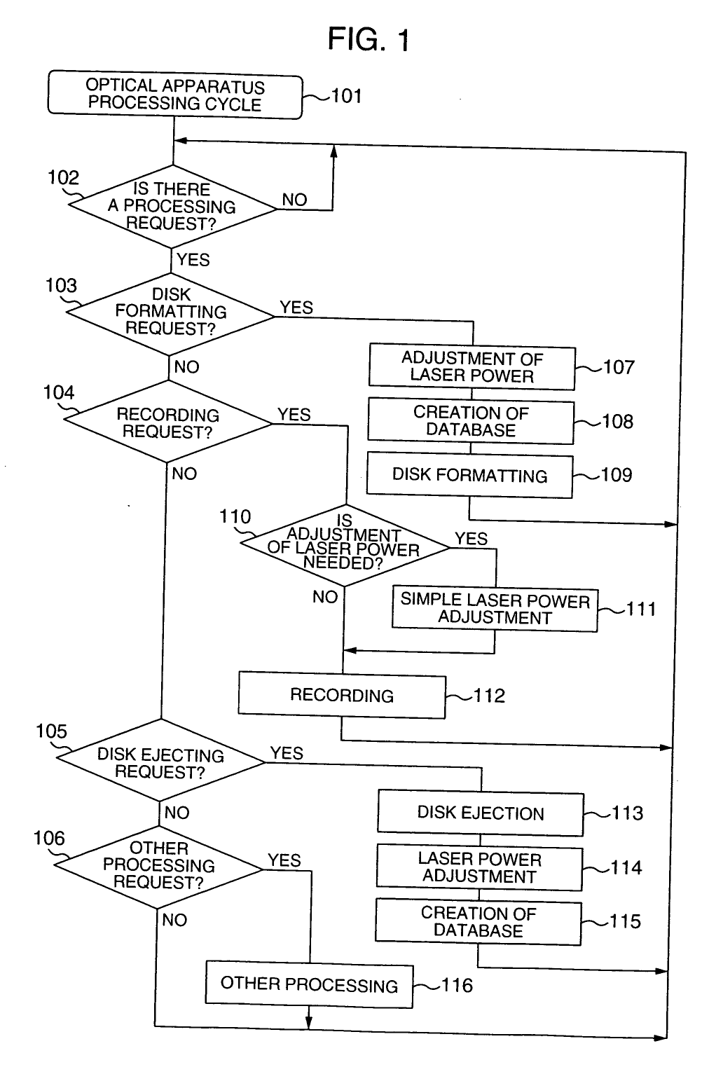

In above, the present embodiments have been described about creating the database concerning temperature characteristics of the laser and completing adjustment of laser power in a short time. The present embodiments also provide the creation of database and usage of the created database. The occasion will be described with reference to FIG. 1. It should be noted that description will be provided based on the premise that the situation is just after an unused DVD-R disk is inserted into an optical disk apparatus.

FIG. 1 is a flow chart illustrating a processing cycle in an optical disk apparatus provided by the present embodiment. When the optical disk apparatus is started up, it waits a processing request from a user. When the optical disk apparatus receives a processing request, it checks the contents of the request and performs processing in accordance with the request. In FIG. 1, 102 is processing performed upon receipt of a request from the user, and 103, 014, 105, and 106 in FIG. 1 check the contents of requested processing. Processing performed in accordance with the contents of requested contents are 107, 108, 109, 110, 111, 112, 113, 114, 115, and 116 illustrated in FIG. 1.

It should be noted that the detailed illustration given in FIG. 1 is limited to the determination of contents of requests related to the description of the present embodiment and processing in accordance with the request thereof, and the determination of contents of requests having no direct relation with the present embodiment and processing in accordance with the requests thereof are collectively dealt as other processing as shown by 106, 116.

After inserting an unused disk into the disk apparatus, the user requests the disk apparatus to format the disk so as to make the disk ready for use. Format is processing for setting a recording mode, assigning recording areas, or the like.

Upon confirming that the content of the user's request is to format the disk in 103 of FIG. 1, the disk apparatus adjusts the laser power in 107 of FIG. 107. The adjustment of the laser power is, as described previously, processing which gradually changes supply power to the user after the pickup is moved to a power calibration area, and simultaneously measures power of the laser to determine supply current which provides target power of the laser.

After finishing adjustment of the laser power, the disk apparatus performs creation processing of a database in 108 of FIG. 1. The database created here is for making the adjusting of laser power after the adjustment of laser power in 107 in a short time, which is particular to the present embodiment.

After the completion of creation of the database, the disk apparatus formats the disk by disk format processing shown in 109 of FIG. 1. With this, the disk gets to ready state. Then, after finishing the format processing, the disk apparatus waits a new request from a user again in 102 of FIG. 1. It should be noted that a series of steps, 107, 108, and 109 in FIG. 1, are performed only once for every disk.

Afterwards, when the user requests the disk apparatus to record data, the disk apparatus confirms the contents the user's request as data record processing in 104 of FIG. 1 to determine whether it is necessary to adjust the laser power in 110 of FIG. 1. The disk apparatus determines whether it is necessary to adjust the laser power in accordance with temperature variations. When temperature variations since the last laser power adjustment are predetermined values or below, record processing shown by 112 is performed. When the temperature variations since the last laser power adjustment excess the predetermined values, a simple laser power adjustment is performed in 111 of FIG. 1, and subsequently the record processing is performed in 112 of FIG. 1.

The simple laser power adjustment shown by 111 in FIG. 1 is processing specific to the present embodiment, and the laser power is determined according to the calculation based on the database created in 108 of FIG. 1. Therefore, the adjustment can be completed in a much shorter time compared with the laser power adjustment shown in 107 of FIG. 1. Thus, it is possible to proceed to the record processing shown in 112 of FIG. 1 at once, and to perform the record processing requested by the user at once.

Conventionally, the laser power adjustment which was made prior to record processing used to take much time like the laser power adjustment shown in 107 of FIG. 107. Therefore, even when the user made a request to record videos in real time, the video recording apparatus which has to record video in real time sometimes did not perform record processing at once, and failed to record video data desired by the user. However, applying the present embodiment to the video recording apparatus, even if the laser power has to be adjusted prior to the record processing, the adjustment is made at once, thus preventing missing to record video data desired by the user.

As described previously, the database for use with the simple laser power adjustment shown in 111 of FIG. 1 is created utilizing the disk formatting. This is because of a desire to perform at a time when the user accepts the much time taken for the processing, which is characteristics of the present embodiment.

Another characteristics of the present embodiment is that the present embodiment also utilizes the time when the disk is ejected from the disk apparatus as an opportunity when to create such a database. When the user requests the disk to be ejected from the disk apparatus, the user's request is confirmed as a disk ejection in 105 of FIG. 1, and the disk ejection processing shown in 113 of FIG. 1 is performed.

During the time period from immediately after the disk is ejected to the time when the disk will be inserted next, it is unlikely that the user makes a request to the disk apparatus. Using the time period, the laser power is adjusted in 114 of FIG. 1. The laser power adjustment in 114 gradually varies the supply current to the laser, and simultaneously measures the laser power to determine a supply current which provides target laser power. Then, the database is created in 115 of FIG. 1 based on the result of the laser power adjustment in 114 and in preparation for the simple laser power adjustment.

The power adjustment during the disk ejection allows actually measuring variations of the laser with time and variations thereof at temperatures different from the time when the recording is started to enhance accuracy of the database in preparation for the next recording.

The second adjustment processing as the simple laser power adjustment in 111 is finished in a shorter time than the first adjustment processing as the laser power adjustment in above 107 or 114. The reason is as follows. In both first and second adjustment processing, the adjustment starts when a signal with which the microcomputer 404 instructs the laser driver 403 to perform the laser power adjustment enters the laser driver. The second adjustment processing does not perform a test write until the first adjustment processing completes several test writes, and can perform measurements at each time until a signal appears to start recording based on the database such as the previous test write.

Further, since the first adjustment processing performs a test write, time or the like is needed for seeking a laser in the test write area of the disk and the laser also emits light. However, the second adjustment is simple adjustment processing that is required only to calculate and determine a power value. Therefore, there arises a difference in time taken between the first and second adjustment processing.

As described above, applying the present embodiment, even if the power has to be adjusted when a request for record processing is made by a user, the adjustment is completed in a short time by means of the database previously prepared, thus making it possible to perform the record processing as immediately as record processing that does not make the laser power adjustment. Further, since the database used for the laser power adjustment is created at the time when the user accepts the much time taken for the processing, the user does not feel abnormal with the responsivity of the disk apparatus.

It should be noted that while above description is made to a laser power adjustment in an optical disk as an example, the feature of the present embodiment will be useful to adjustments other than the laser power adjustment should they be able to utilize the database to multiply the speed of the adjustment processing, and to use the time period when the user accepts the much time taken to create the data.

FIG. 5 is an embodiment in which the present invention is applied to a DVD camera. In the DVD camera 300 of FIG. 5, a lid is opened before a disk is inserted into a storage unit 302. The DVD camera also makes above-mentioned laser power adjustment, and yet can start record processing in a short time when a user performs video recording.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method of adjusting a disk apparatus, the method comprising steps of:
performing format processing so as to make a disk inserted into the disk apparatus ready for use, or performing first adjustment processing during ejection processing for ejecting the disk from the disk apparatus;
performing second adjustment processing when recording data onto the disk,
wherein said second adjustment processing is finished in a shorter time than said first adjustment processing.

2. A method of adjusting the disk according to claim 1, wherein said first adjustment processing of the disk apparatus comprises adjusting processing of laser power for use in disk recording.

3. A method of adjusting the disk according to claim 2, wherein the adjustment processing of the laser power in said first adjustment processing is performed by a test write to the disk.

4. A method of adjusting a disk apparatus, the method comprising steps of:
performing format processing for making a disk inserted into the disk apparatus ready for use, or performing adjust processing of the disk apparatus during ejection processing for ejecting the disk from the disk apparatus, and
using the results of the adjustment processing of said disk apparatus when recording the data onto the disk.

5. A method of adjusting the disk apparatus according to claim 4, wherein said adjustment processing of the disk apparatus comprises adjustment processing of the laser power for use in disk recording.

6. A method of adjusting the disk apparatus according to claim 5, wherein the adjustment processing of the laser power is performed by a test write onto the disk.

7. A disk apparatus, the disk apparatus comprising:
means for format processing so as to make a disk inserted into the disk apparatus ready for use, or for performing first adjustment processing to be performed during ejection processing for ejecting the disk from the disk apparatus, and
means for second adjustment processing to be performed when recording data onto the disk,
wherein processing performed by the second adjustment processing means is finished in a shorter time than the processing performed by the first adjustment processing means.

8. A disk apparatus according to claim 7, wherein said first adjustment processing means of the disk apparatus comprises the adjustment processing of the laser power for use in the disk recording.

9. A disk apparatus according to claim 8, wherein the adjustment processing of the laser power in said first adjustment processing means is performed by the test write onto the disk.

10. A disk apparatus, the disk apparatus comprising:
means for performing format processing so as to make a disk inserted into the disk apparatus ready for use or for adjustment processing the disk apparatus during ejection processing for ejecting the disk from the disk apparatus, and
means for performing recording using the results of the processing by the adjustment processing means of said disk apparatus when recording data onto the disk.

11. A disk apparatus according to claim 10, wherein said means for adjustment processing of the disk apparatus comprises adjustment processing of the laser power for use in disk recording.

12. A disk apparatus according to claim 11, wherein processing by the adjustment processing means of the laser power is performed by a test write onto the disk.

13. A disk apparatus according to any of claims 7 or 10, wherein the disk apparatus is applied to a camera for recording videos.

14. A method of adjusting a disk apparatus, the method comprises steps of:
performing adjustment processing necessary for the disk apparatus when performing first processing to the disk apparatus,
recording the results of the adjustment processing acquired by said adjustment processing onto a database, and
wherein when performing second processing of the disk apparatus, the second processing is performed after the adjustment processing is performed based on the data of said database.

15. A method of adjusting the disk apparatus according to claim 14, wherein:
said first processing is format processing in the disk apparatus for making a disk inserted into the disk apparatus ready for use, or processing performed during the time when the disk is ejected;
said second processing is record processing of data, and
adjustment processing necessary for said disk apparatus is adjustment processing of the laser power for use in disk recording.

16. A disk apparatus, comprising:
a database for holding data;
means for performing adjustment processing necessary for the disk apparatus when performing first processing to the disk apparatus;
means for recording the results of the adjustment processing acquired by said adjustment processing onto the database, and
means for adjustment processing for performing adjustment processing to the disk apparatus based on the data held by said database when performing the second processing to the disk apparatus.

17. A disk apparatus according to claim 16, wherein said first processing is format processing for making the disk inserted into the disk apparatus ready for use, or processing performed at the time when the disk is ejected from the disk apparatus, wherein said second processing is record processing of data, and adjustment processing necessary for said disk apparatus is the adjustment processing of the laser power for use in disk recording.

18. A disk apparatus according to claim 17, wherein the disk apparatus is applied to video recording.
